(19) United States
(12) Patent Application Publication
(10) Pub. No.: US 2024/0097488 A1
(43) Pub. Date: Mar. 21, 2024

(54) Fly-Ring Energy Storage Systems and Methods

(71) Applicant: Daniel Klotzer, Saint Louis, MO (US)

(72) Inventor: Daniel Klotzer, Saint Louis, MO (US)

(21) Appl. No.: 18/518,739

(22) Filed: Nov. 24, 2023

Related U.S. Application Data
(63) Continuation of application No. PCT/US22/30758, filed on May 24, 2022.
(60) Provisional application No. 63/192,550, filed on May 24, 2021.

(51) Int. Cl. H02J 15/00

(52) U.S. Cl. CPC H02J 15/007

(57) ABSTRACT

A kinetic energy storage system (KESS) incorporating a very large revolving ring. The ring is levitated magnetically and rotates in place along a defined raceway associated with the levitating apparatus. Power electronics are able to store energy in the form of accelerated rotation of the ring, and are able to reclaim that energy by using the slowing of the ring to drive electricity regenerators. Specific material and size requirements are described for some of the embodiments, and various manners of maximizing the angular velocity of revolution to enable greater energy storage capacity are detailed.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

The present invention relates generally to energy storage, and more particularly to storing energy as the kinetic energy of a mass moving in place.

### Related Art

Modern society has become both more dependent on the operation of the electrical grid while placing ever greater demands on the grid's capacity, stability, frequency stability, and dynamic matching of power supply to demand load. These circumstances were in place even before the climate crisis placing a paramount importance on the production of energy with sustainable sources such as wind and solar. While the ability of these sources to provide substantial energy is real, they are severely limited in their ability to produce energy magnitudes just as desired whenever desired and to not do so when not desired. The solution is energy storage, with certain characteristics.

Energy storage is the goal, but its form, cost and operating parameters need to satisfy various criteria in order to environmentally, energetically, efficiently and effectively solve one or more of the problems involved in running and supplying a modern electrical grid. Especially if the desire is to run the grid entirely on (unpredictable, uncontrollable) renewable sources. Of course cost is a factor both in and of itself and as a critical aspect of each and every other part of these considerations, and can be considered an unspoken added key attribute of anything under consideration. Businesses don't run uneconomical operations and stick around for long. In general, almost any question we consider can be considered to be both asking that particular question and the accompanying question “at what cost?” unless it was already known that the cost was not an issue. Among the needs that grid operators would like to ameliorate, if not solve, are frequency regulation, peak demand production, grid inertia, time-shifting (hours to days between production and use) energy storage, transmission congestion reduction (re distributed storage/provisioning) and greater utilization of less controllable sustainable resources. In addition, substantial distributed storage eases overall grid transmission volume, since a power supply is then likelier to be closer to a load in need. As is well-known, sundry further reasons make improved energy storage a much desired capability.

The size of the need and the significance of the benefits gained by improvements in energy storage is not new. The Romans piled up stones to operate pulleys, and using elevated water to drive stone grinders may predate written records. In the current situation, the need for improved energy storage is not just necessary to accomplish goals, but it may even be key to solving an existential crisis. As the significance of the climate crisis becomes all too clear, the need for converting the electrical power systems to exclusively sustainable resources is both certain and depends crucially on the quality and quantity of energy storage. Energy storage, in potentially a variety of forms to meet a variety of needs, is key because while sustainable resources can handle the overall demand, aspects of how the demand is met are more difficult. The most common sustainable sources are wind and sum, which are famously always going to come back, but are never going to appear on demand. The electrical grid is a pipe that needs to be filled more as it's emptying rate increases, immediately, in phase and in proportion, and needs to be filled less as the empting rate decreases, immediately, in phase and in proportion. The fossil fuel sources to be replaced are not infinitely flexible, but their performance is predictably known and available within their operating parameters on demand. The need for energy storage is so that the unpredictable renewable energy sources like wind and sun can provide the on demand performance necessary to fully replace fossil fuel power sources.

Many differing types of energy storage (ES) are in use or research and development. Those relevant to the grid now or potentially in the future include electrochemical batteries, gravitational water storage, ultra-capacitors, flywheels, compressed air ES, thermal ES, Hydrogen, ammonia (liquid), and others. Each differ in cost, energy density, power density, cycle life, energy capacity, speed of ramp up, inertial substitution, efficient storage life, operational lifetime, reliability, maintenance requirements, estimated uptime, repair downtimes, and site requirements. Thus far, differing options have been shown to be best for one of the various capabilities needed to maintain the grid in operational health, sometimes two. None are yet able to meet a substantial number of the needs. None are yet able to handle even a single need's cost and performance demands effectively enough to be considered a “happy” long term answer at present. Most significantly, none are able to produce that “happy” level of performance/cost for many of the grid operation needs all at once.

### SUMMARY OF THE INVENTION

To cost effectively address a number of the modern electrical grid's operational needs for various functions from energy storage assets, the present Fly-Ring systems and methods invention is described and claimed herein. Various embodiments of the Fly-Ring can provide at least one or more of the following grid operation capabilities: 1. Grid inertia; 2. Fast varying (tens to fractions of seconds) peak load increase & decrease responses; 3. Frequency regulation; and 4. Time shifting energy storage to match power supply at one time of a day to demand load occurring at a different time of the day. Currently, each of these capabilities is often separately addressed with differing facilities using differing methods at differing levels of performance and cost, and each are separately remunerated according to differing markets. The Fly-Ring can provide each of these functions, (generally with greater capacity, better performance and less cost than existing options,) both individually and in combinations at the same time. Hence, the Fly-Ring both improves grid performance and reduces costs, while garnering multiple levels of compensation for differing forms of performance provided simultaneously.

Kinetic energy storage systems such as flywheels are a long established and widely adapted technique. One well-known way to have more efficient energy storage per kg of rotating mass (or rotor) is by using a denser material mostly disposed near the outer radius of the rotor. This approach, like any other with a flywheel, has to be cognizant of the stress limits of the material(s) that the flywheel is constructed from as well as the structural design. In general the hoop stress is the greatest threat to the flywheel retaining structural integrity. This is because in theory, if one were to assume a perfect material with an infinite capacity for stress, there is no limit to the amount of energy that can be infused in a rotating mass short of the rotor's outer edge reaching the speed of light. Hence, in many regards when designing a flywheel system for bulk energy storage, it seems the entire game is won or loss depending on how fast a rotation is able to be safely accomplished. Hence the fixation on various engineering expressions for I, the moment of inertia (=[MASS]×[DISTANCE from center of rotation]²) and ω, the frequency of rotation, since the rotational kinetic energy=½ I ω². A related expression defines the centripetal force pulling rotating matter outward, which is the ultimate co dependent factor in the hoop stress that limits the speed of rotation a particular material can handle. When these quantities are only described in terms of I and ω, as most engineering formulas do, certain relationships can become “unobserved”.

One such potentially unobserved detail is that the variable part of the tangential stress, which we wish to minimize for maximum energy storage, grows in relation to a single power of R, the rotational radius, while the rotational energy, which again we wish to maximize, grows in relation to the second power of R. When the typical equivalent engineering expressions are used, which express quantities in terms of I and ω, this distinction can become unobserved.” The present novel application of this difference in dependence on R enables the present Fly-Ring to achieve higher levels of energy storage than many approaches that operate at higher rotational frequencies by its form encompassing unprecedentedly large rotational radii for a high speed kinetic energy storage system (KESS).

Primary distinctive aspects (individually or in selected combinations) incorporated in varying embodiments of the present invention include:
A. An overall form corresponding to a 360 degree section of a cylinder wall with inner radius Rᵢ and outer radius R₀;
B. Varying Fly-Rings heights with the same planar dispositions to provide correspondingly varying energy storage capacities;
C. Fly-Rings composed of modular planar plates to enable capacity tailoring and differing operations by differing plates of a single Fly-Ring;
D. An overall size of 5 meters or greater diameter with an empty central interior of 3 meters or greater, and in particular specific embodiments with an Rᵢ−R₀=ΔR of about 1 meter and an overall diameter of 7 meters or greater;
E. An overall rotational weight of greater than 200 metric tons, with particular embodiments in the 500-2500 metric ton ranges to enhance, among other attribute, the amount of grid inertia these embodiments can provide;
F. An absence of any spindle, hub, bearing, or co-moving apparatuses disposed within the Fly-Ring's interior space (R<Rᵢ);
G. Relatively dense metallic alloy(s) as a primary structural material for a high speed KESS;
H. Metallic alloys with substantially enhanced tensile yield strengths, for example a maraging steel alloy;
I. Levitation of the Fly-Ring with a system (for example, an Inductrack) using permanent magnets disposed along the Fly-Ring or a raceway in which the Fly-Ring rotates in place;
J. Power electronics disposed in sufficient proximity to the Fly-Ring to enable contactless electromagnetically mediated investment of energy by acceleration of the Fly-Ring and retrieval of invested energy by deceleration of the Fly-Ring;
K. Evacuation, at least partially, of an enclosed channel in which the Fly-Ring rotates;
L. Augmentation of the metal alloy with one or more hyper-tensile strength materials (Aramid fibers, ultra-high molecular weight polyethylene, etc.) having lesser flexibility than the metal alloy, disposed in relation to the alloy such that as the rotational speed increases and the Fly-Ring expands in response, the later stages of its expansion are also resisted by the hyper-tensile strength material so that the final tensile strength of the Fly-Ring becomes the tensile strength of the metal alloy added to that of the hyper-tensile strength material;
M. Magnetization of the metal alloy Fly-Ring material such that it will experience electromagnetic forcing when in a magnetic field, and arrangement of an external magnetic field in relation to the magnetized Fly-Ring such that the electromagnetic forcing at least partially opposes the centripetal outward force being experienced by the Fly-Ring due to rotation; and/or
N. Electrostatic charging, likely negative charging, of the metal alloy material of the Fly-Ring such that it will experience electrostatic forcing when in an electrostatic field, and arrangement of an external electrostatic field in relation to the electrostatically charged Fly-Ring such that the electrostatic forcing at least partially opposes the centripetal outward force being experience by the Fly-Ring due to rotation.

One common set of attributes shared by a number of embodiments of the present invention are a constitution of primarily a high tensile strength metal alloy; a spatial arrangement as an entirely coreless ring with an R₀ of at least 4 meters and thickness ΔR of under 3 meters; a rotational weight of at least 200 metric tons and frequently over 400 metric tons; a raceway foundation and magnetic levitation system which accommodates and levitates the metal alloy ring as it follows itself, endlessly rotating; and a power electronics system which accelerates or decelerates the ring's rotation when it receives or returns energy, respectively. Not uncommon additional attributes are a (toroidal) evacuated chamber enclosing at least the metal alloy ring; a magnetic field producing apparatus and magnetizing of the ring combining to apply a centripetal force counterbalancing magnetic force; an electrostatic field producing apparatus and electrostatic charging of the ring combining to apply a centripetal force counterbalancing electrostatic force; and an ultra-high tensile strength material interrelated with the ring such that the augmented ring has a greater tangential stress capacity.

Other objects and features will be in part apparent and in part pointed out hereinafter.

### BRIEF DESCRIPTION OF THE DRAWINGS

FIG. 1 depicts a schematic top down cross-section view of a representative Fly-Ring and associated raceway first embodiment of the present invention.

FIG. 2 depicts a schematic top down cross-section view of a representative Fly-Ring and associated raceway second embodiment of the present invention.

FIG. 3 depicts a schematic perspective view of a representative Fly-Ring, associated raceway, and siting for a below grade installation of a third embodiment of the present invention.

FIG. 4 depicts a schematic perspective view of a representative Fly-Ring, associated raceway, and siting for a below grade installation of a fourth embodiment of the present invention.

FIG. 5 depicts a schematic enlarged detail cross-section view of an end-plate electromagnetic field interacting assembly aspect of a fifth embodiment of the present invention.

FIG. 6 depicts a schematic cross-section detail view of a first assembled plates Fly-Ring aspect of a sixth embodiment of the present invention.

FIG. 7 depicts a cross-section schematic perspective view of a siting suitable for a number of the representative embodiments of the present invention.

FIG. 8 depicts a schematic cross-section detail view of a second assembled plates Fly-Ring aspect of a seventh embodiment of the present invention.

FIG. 9 depicts a schematic perspective view of a the disposition of a first form of Fly-Ring failure mitigation relative to the siting of a suitable embodiment of the present invention.

FIG. 10

FIG. 11

FIG. 12

FIG. 13

FIG. 14

FIG. 15

FIG. 16

FIG. 17

FIG. 18

FIG. 19

FIG. 20

FIG. 21

FIG. 22

### DETAILED DESCRIPTION OF THE PREFERRED EMBODIMENTS

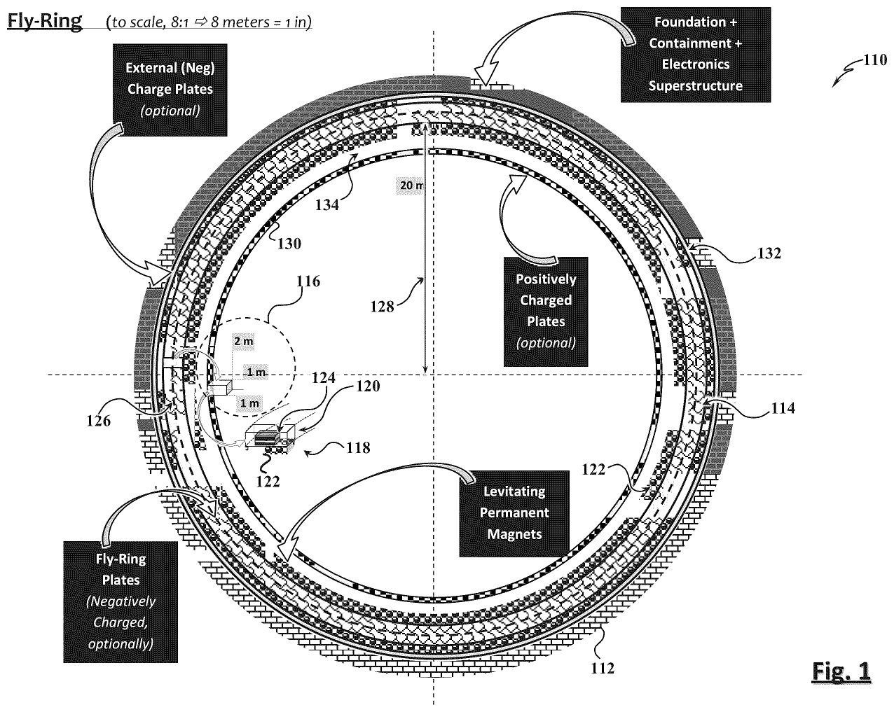

A first embodiment of the present invention shown in FIG. 1 depicts a Fly-Ring and associated raceway first embodiment 110 from a top down view. A raceway foundation 112 surrounds the Fly-Ring 114 and provides a foundation and space for the operation of the Fly-Ring 114 and associated equipment. Two different versions of the Fly-Ring 114 are shown, with a 2 meter width (≡ΔR=R₀−Rᵢ), and 1 meter height as seen in dashed circle 116. A further expanded detail view 118 of the ring section shown in 116 reveals an enclosed raceway 120 that can be partially or fully evacuated and an associated magnetic levitating apparatus 122 such as Helmholtz Coils for an Inductrack or an array of permanent magnets, and that the Fly-Ring can have unitary construction or be composed of a stacked set of plates 124. An alternative geometry for the Fly-Ring is shown by optional outer border 126 that is at a radius R only about a meter larger than the R₀ inner border distance 128. Of course whatever the geometry in the plane of the Fly-Ring 114, capacity can still be varied by varying the height, wherein more height equals more capacity for a given planar geometry. Optional additional aspects include electromagnetic (EM) confinement, named so due to it being configured to at least partially counterbalance the outward forcing of the Fly-Ring 114 rotational motion. A pair of options are available, one using magnetic forces (the written labels in FIG. 1 all refer to electrostatic and not magnetic confinement, but are not limiting), and the other using electrostatic forces, both in any of a number of well-known ways to effect a relevant field and relevant magnetization (in the case of magnetic forcing) or electrostatic charging of an object that is to be forced by that field. The EM field production can arise from one of or both of two locations, either concentrically and symmetrically arranged along an interior band 130 or also concentrically and symmetrically arranged along an exterior band 132. To be effective both bands 130 and 132 must be well attached to the foundation, in order to be able to anchor the EM forces they will apply. Further options include varying the strength of the EM fields used to vary the force applied, as well as varying the positioning of the bands 130 and/or 132 relative to the Fly-Ring 114, since EM forces vary in proportion to the distance across which they reach by a factor: 1/R². Hence, for example, moving the electrostatically charged band 130 closer to the Fly-Ring 114 will increase the force it exerts on the Fly-Ring 114. Since the Fly-Ring 114 will expand as its rotation speeds up, the movement of band 130 may be needed to merely keep its forcing steady. Similarly, the band 132 may be made moveable as well if only to maintain some distance from the expanding Fly-Ring 114. Of course, varying the amount of the electrostatic charge and/or magnetization will also vary the forces as well.

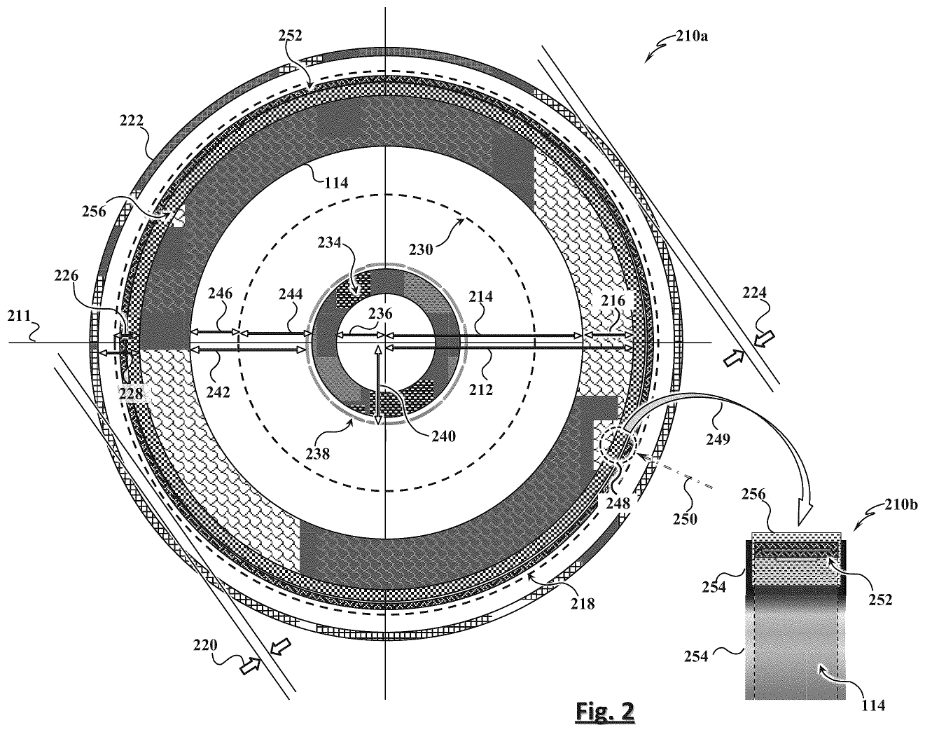

A second embodiment of the present invention shown in FIG. 2 depicts alternative dimension options for the Fly-Ring 114 and associated raceway second embodiment 210a, also from a top down view. Among a number of situational factors, the configuration of the second embodiment 210a is well suited for a smaller installation footprint than the first embodiment 110. In order to enable a larger energy storage capacity than would be possible otherwise, additional features are incorporated including (a) manners of utilizing ultra-high tensile strength polymers, fibers, carbon fiber impregnated resins, fiberglass varieties and other materials to selectively augment the tensile strength of the metal alloy from which the Fly-Ring 114 is primarily fashioned; (b) manners of utilizing external (to the Fly-Ring 114) magnetic fields and magnetization of the Fly-Ring 114 (or magnets embedded within the Fly-Ring 114) to effect differing forms of magnetic forcing, in particular using that forcing to at least partially counterbalance the centripetal forces that aggregate to produce the tangential stresses which could threaten the integrity of the Fly-Ring 114 itself when rotating at a high velocity; and (c) manners of utilizing external (to the Fly-Ring 114) electrostatic fields and electrostatic charging of the Fly-Ring 114 to effect differing forms of electrostatic forcing, in particular using that forcing to at least partially counterbalance the centripetal forces that aggregate to produce the tangential stresses which could threaten the integrity of the Fly-Ring 114 itself when rotating at a high velocity. The tangential stress involves a number of components and factors, but in general is proportional to the centripetal forces impacting each section of the Fly-Ring 114. Hence, reducing the centripetal force by 25%, for example, should enable a close to 25% reduction in the tangential stress as well. Since the tangential stress is the limiting speed of revolution factor, the 25% cut in centripetal forces could translate into a major increase in energy capacity for that size of Fly-Ring 114.

Many of the spatial dimension variations in FIG. 2 also take advantage of the use of unprecedentedly large radii of revolution, even for the smaller versions of the Fly-Ring 114, to enable substantial and often unexpected new capabilities in differing embodiments of the present invention. In the field of designing an effective KESS seemingly small dimensional differences can be the crux of success and are always of importance. Any ESS, KESS or battery or whichever, must be able to integrate with a variety of other grid equipment and demands, cost effectively and performing reliably, has to balance a number of competing requirements. Plus, the ESS components have a number of individual issues to satisfy such as install size, cost, maintenance needs, lifetime, energy round trip efficiency, power transfer magnitude, reliability, one time and ongoing operating expenses, and so on all of which are affected, sometimes dramatically, by structural aspects of the ESS with just the right dimensional extents and relative size relationships. For example, A 6 meter R₀, 4 meter Rᵢ Fly-Ring 114 of one meter height having a weight of 503,000 Kg has an ultimate energy storage efficiency Watt-h/Kg, which can be increased by over 17% if the dimensions are merely changed to meter R₀, 9 meter Rᵢ and one meter height for a weight 478.000 Kg. By raising the height to 4 meters and increasing Rᵢ to 9.75 meters results in about the same weight of Fly-Ring 114, but The efficiency is boosted another 5%. In the realm of energy storage technology improvements, an improvement of even one or two percent, or less, can be of crucial or existence determining importance. The ability to improve efficiency by double digit percentages with relatively modest spatial variations (the more and most efficient 10/9 or 9.75 meter-radii Fly-Ring 114 weight and spatial footprints actually drop about 5%,) is an indicator of the significance of the present innovation over the state of the art.

Among the relevant spatial dimensions of the Fly-Ring 114 (as measured relative to rectangular axes 211) are R₀ 212, Rᵢ 214, ΔR 216, a maximum extent R₀ 218 (the maximum extent to which the Fly-Ring will be extended by centripetal forces when rotating at maximum speed) that is spaced by a distance 220 inward from an outer raceway boundary 222 having a width 224. In a generic disposition as shown in FIG. 2 the Fly-Ring 114 is a distance 226 from it maximum extent, and a distance 228 from the boundary 222. The radii 230 is the minimum extent of the Fly-Ring 114, such as when at rest, and the distance 232 is the amount that the Fly-Ring 114 has grown when revolving at a generic speed and extent. Please note, the absolute sizes of the distances 232 and 226 are substantially exaggerated in FIG. 2, relative to the size of the Fly-Ring 114 itself and are depicted in oversized scale in order to enable clarity of illustration and description. When electrostatic (or magnetic) counter-centripetal forcing is applied, a first manner of inducing such an electrostatic (magnetic) field is to apply that field from a source disposed centrally within the coreless interior space of the Fly-Ring 114, from a radial disposition of lesser R than the smallest R₀ 230 of the Fly-Ring 114. A circular inner buttress 234 of radius 236 secures an array of plates 238. The plates 238, depending on the embodiment, can be made into the source of a magnetic field by magnetization, incorporation of magnets and/or by electro-magnetization in which moving charges produce a magnetic field. In particular with electromagnets, the magnitude of the induced magnetic field impacting the Fly-Ring 114 can be varied by altering the movement of the charges in the case of an electromagnet, or by changing the positioning of the plates 238, relative to the Fly-Ring 114. The option of moving the plates 238, and in particular moving them towards greater and greater R_{P} 240 so that they are closer to the Fly-Ring 114, is of particular utility since as the Fly-Ring 114 moves faster and faster, its (Rᵢ−R_{P})=the distance that the EM field is lessened by the factor 1/(Rᵢ−R_{P})², grows. When the Fly-Ring 114 is at its fastest movement and hence its Rᵢ is maximized, the EM field reduction by the factor 1/(Rᵢ−R_{P})² is hence also greatest, so that moving the plates 238 radially outward in at least partially synchronization with the speed induced stretch of the Fly-Ring 114 will both compensate for the speed induced increase in plate separation R_{SP} 242, and by moving the plates sufficiently to not enlarge R_{SP} 242 the EM force countering the centripetal forces can be maintained without need to alter the field generation, or even increased by reducing the distance R_{SP} 242. When at a generic speed, the separation R_{SP} 242 can be considered the combination of a starting separation R_{Po} 244 that increases by an amount R_{Ps} 246 when the Fly-Ring 114 is revolving at a generic speed S.

An expanded detail view 210b of the area within dashed circle 248, rotated 90 degrees 249 so that the detail view 210b is seen from the perspective line of sight 250. The view 210b is a schematic hybrid of a partial perspective view of the Fly-Ring 114 and a cross-section view of an ultra-high tensile strength reinforcement 252 (e.g. Aramid fiber, ultra-high molecular weight polyethylene, fiberglass, carbon fiber impregnated resin, Dyneema®, and their equivalents) to the Fly-Ring 114 primary metal alloy material. The metal alloy, which will be described in substantially more detail subsequently, will generally have a predictable degree of elastic response to a particular degree of centripetal forcing so that when the Fly-Ring 114 is revolving at a certain speed the amount of radial size increase of the Fly-Ring 114 will be a known amount. Even when a specific alloy with an unusually high tensile strength is used for the Fly-Ring 114, there are generally a number of other engineered materials that have an even higher tensile strength such as those listed and others which are suitable for use as reinforcement 252 in germane embodiments of the present invention. These engineered materials will also stretch some when under extreme stress, but normally well less than the amount of stretch available with the engineered materials. Because the engineered materials generally cost an order of magnitude or more than the metal alloy, they are not cost effective as an exclusive Fly-Ring 114 constituent material. Hence the goal is to use the engineered material judiciously to extend the maximum tensile yield strength of the combined metal alloy by the additional amount afforded by the engineered material. An additional inventive aspect of the use of the engineered material is a form of staged utilization that adds the individual tensile strengths of the metal alloy and the engineered material rather than merely using the engineered material's strength and in essence wasting the additional tensile strength of the alloy. Prior uses of an engineered material to reinforce a KESS make the mistake of having the engineered material's resistance to stretching come into play too soon, which occurs when the engineered material is wrapped too closely or disposed to be stretched too soon, relative to the stretching of the Fly-Ring 114. As a conceptual but still fairly correspondent to reality illustration, since each engineered material has unique attributes, consider an engineered material with twice the tensile strength of the metal alloy being used but only 20% of the total stretch. A specialized arrangement is necessary wherein as the centripetal force grows, the majority of the stretching of the alloy does not perturb the engineered material reinforcement, and only in the last 20% of the alloy's stretch, in this case, will the engineered material also be stretched. In this way the two tensile strengths would be additive to a total tensile strength that exceeded that of either, rather than merely replacing the ultimate strength of the engineered material for that of the metal. To do so, the ring 114 is seen to further comprise a edge flanges 254 which hold a spacer element 256 that fits within the space between the flanges 254 and holds the engineered material reinforcement 252 at a spacing from the ring 114. The spacer element 256 is constituted from one or more materials that have essentially no (or very little) resilience or elasticity, as well as relatively little resistance to compression. Hence, as the Fly-Ring 114 expands due to centripetal force, the element 256 compacts between the growing Fly-Ring 114 and the unyielding engineered material 252 with the engineered material 252 remaining relatively unstressed until the Fly-Ring 114 expands so much that no more space remains for the element 256 to compact further between it and the engineered material 252. At that point, in the present representative, but not limiting, case being described, the point of meeting between the Fly-Ring 114 and the engineered material 252 occurs when the Fly-Ring has expended 80% of its stretch. At that point, the remaining 20% of the metal alloy stretch overlaps with about 100% of the engineered material stretch, such that the two (or more) materials' tensile yield strengths are cumulative in their resistance to centripetal forcing and hence the maximum tensile yield strength of the Fly-Ring 114 plus reinforcement 252 is greater than the Fly-Ring 114 alone.

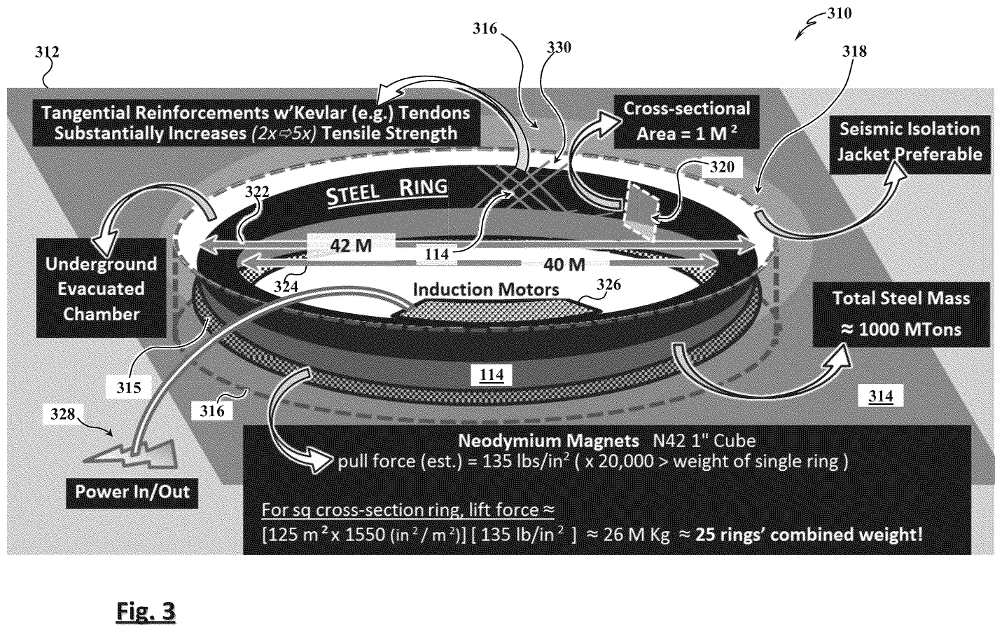

A third embodiment of the present invention shown in FIG. 3 depicts a schematic perspective view of the Fly-Ring 114 and aspects of its siting from a third embodiment 310. A representative rectangular site 312 that may have a specific form of fill 314, shows that a common means of deployment of the Fly-Ring 114 is a below-grade, though shallow, disposition with the Fly-Ring, magnetic levitating associated raceway 315 and other related aspects occupying a cylindrical excavation 316, which can be surrounded 318 with a variety of forms of Fly-Ring 114 safety measures designed to arrest any portion of the Fly-Ring 114 that could be ejected in a failure. The Fly-Ring 114 shown in FIG. 3 has a cross-section 320 of 1 square meter, an outer radius 322 of 42 meters and an inner radius 324 of 40 meters. Due to the size of the 42 meter diameter Fly-Ring 114 its interior provides substantial space for power electronics such as an induction motor 326 that enable transfer of power to and from a source/network 328. An optional reinforcing web of the engineered material 330 is seen interrelated with the Fly-Ring 114 such that as the Fly-Ring 114 expands with increasing rotational speed, the manner in which the engineered material 330 is wound about the Fly-Ring 114 allows it to tighten the wrapping of the engineered material 330, without yet stretching the engineered material 330. That wrapping approach once again enables the metal alloy to undergo the majority of its stretching before the engineered material 330 is stretched, so that only the last portion of the metal alloy stretch remains and overlaps when the engineered material 330 is stretched. This option also enabled the combining of the tensile strengths of the metal alloy and the engineered material, rather than merely substituting one for the other.

A fourth embodiment 410 of the present invention shown in FIG. 4 depicts a schematic perspective view of the Fly-Ring 114, aspects of its siting, and variations from the third embodiment 310. These variations include an outer diameter 412 of 24 meters and an inner diameter 414 of 20 meters. An additional differentiation from the third embodiment 310 is the utilization of a particular steel alloy termed maraging steel (and similarly performing alloys) that has a particularly large tensile yield strength (one alloy, marketed as maraging 350, has a reported tensile yield strength of 340,000 psi). The maraging and related high tensile strength alloys enable greater kinetic energy storage capacity that also unlocks new levels of efficiency.

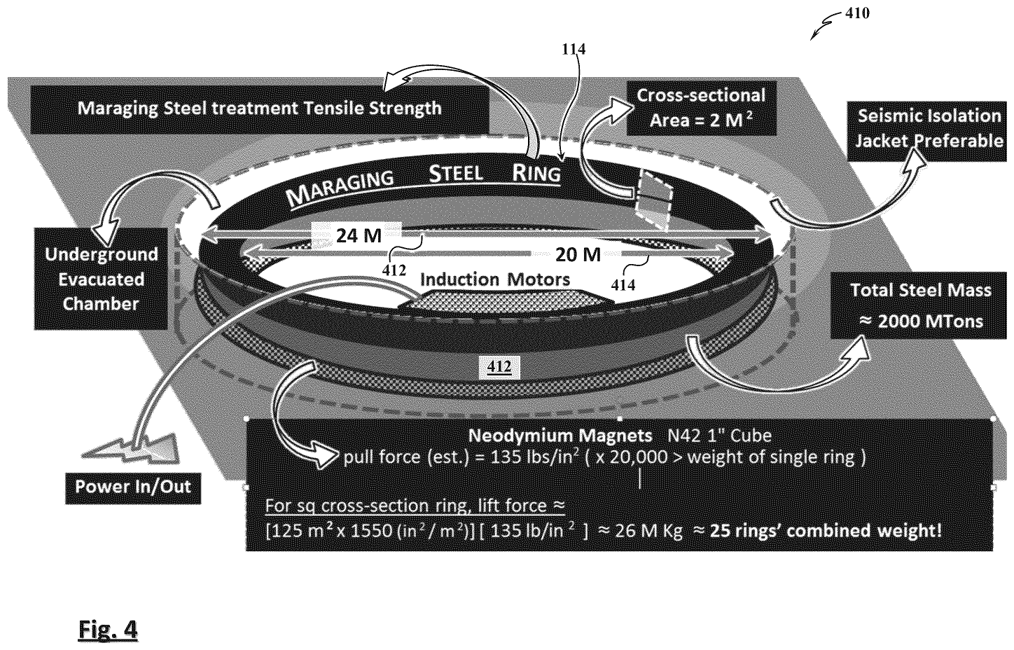

A fifth embodiment of the present invention shown in FIG. 5 depicts a schematic cross-section view of first radially exterior portions 510 of an assembly of the Fly-Ring 114, its construction from plates 512, and aspects of the Fly-Ring plates 512 interactions with an EM field producing arrays 513 of magnetized or electrostatically charged EM plates 514 which are spaced in relative close proximity 515 to the plates 512 and their associated extension flanges 516 to enhance their counter-centripetal forcing effects. In many cases, the region 518 in which the Fly-Ring flanges 516 and the EM plates 514 interact can be evacuated similarly to the region in which the Fly-Ring 114 revolves can be evacuated. A foundation 520 will be required to enable the application of sufficient force by the EM plates 514, with its dimensions 522 and 524, along with inset 526, being construction options that enable overlapping arrays 513, as well as overlapping exterior portions 510 to maximize the amount of magnetic or electrostatic forcing that can be applied to the Fly-Ring plates 512.

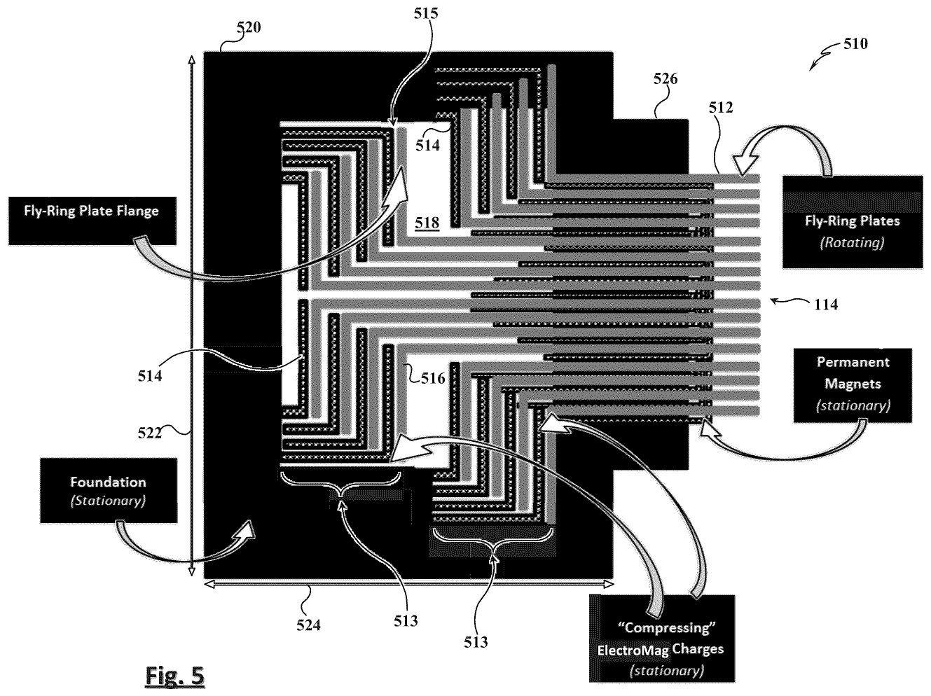

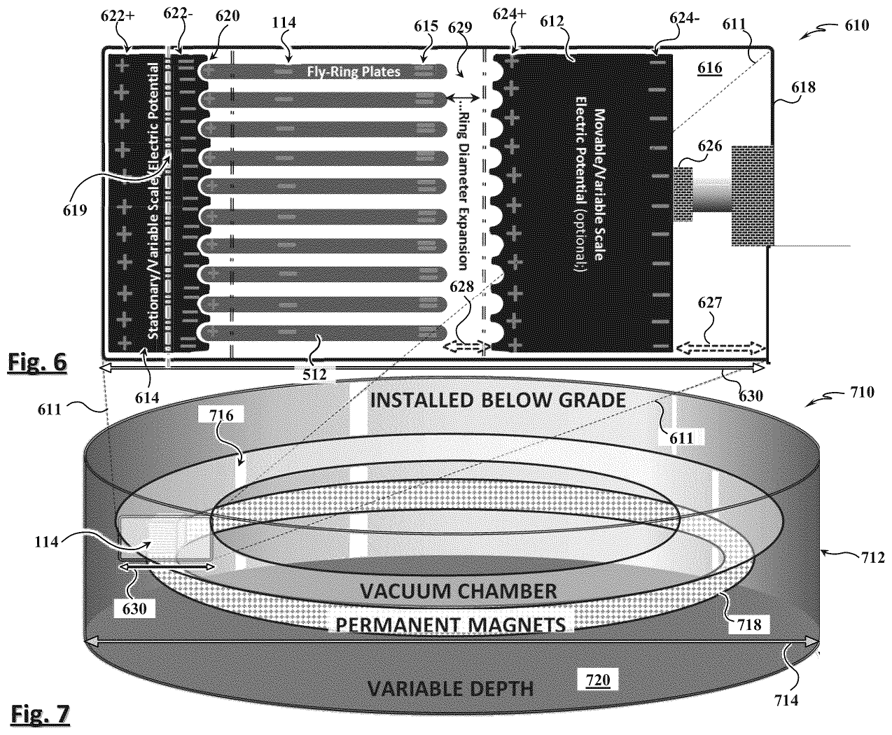

A sixth embodiment of the present invention shown in FIG. 6 depicts a schematic expanded detail cross-section view of a second Fly-Ring radially exterior portion 610 (shown in scale to an entire Fly-Ring 114 by dotted connecting lines 611), including its interactions with electrostatic forcing internal plates 612 or external plates 614. The Fly-Ring plates 512 are given a negative charge, for example by applying an electric potential between the plates 512 and an outside source and then interrupting the circuit while the potential is in full effect. The actual distribution 615 of the charge within the plates 512 will reflect both the overall charge the plates 512 are invested with, as well as the externally applied EM field. As shown in FIG. 6, due to a large enough negative electrostatic field adjacent the radial outside edge of the plates 512, there can be a localized concentration of positive charge at that end of the plate, even though the plate as a whole is negatively charged. Similarly, due to a large enough positive electrostatic field adjacent the radial inside edge of the plates 512, there can be a localized excess concentration of negative charge at that end of the plate, even though the plate as a whole is otherwise uniformly negatively charged. If the plates construction were to interfere with the mobility of the charge, such as by a plurality of non-conducting radially alternating layers (not shown), then the charge would be rendered more uniform irrespective of the external fields. In the sixth embodiment, due to the use of electrostatic fields and the potential detrimental effects of an intermediate gas, it will often be preferable to evacuate the interior 616 of a defined space 618 in which the Fly-Ring 114 revolves to inhibit any gas related issues in addition to reducing drag and hence increasing longer-term energy storage efficiency. In the particular, non-limiting sixth embodiment the external electrostatic fields are being supplied by the separate internal and external source plates 612 and 614, respectively, which are also separately enabled as to how they can vary their effective (i.e. felt by the ring plates 512) electrostatic field. A first form of effectiveness variation involves altering, or not, the separation distance between the plates 512 and either of the plates 612 and 614. EM fields attenuate according to a separation distance R dependent factor: (R⁻²). As the speed of revolution increases, the Fly-Ring 114 will stretch somewhat, and hence its external edge will reach a greater and greater radius, short of its limiting velocity. Since that limiting velocity, and hence the maximum safe operating radius, is known in advance, the positioning of the plates 614 can be placed, when desired, in precise proximity to that radius. Since this also defines the minimum excavation size needed to house the Fly-Ring 114, which is also useful to be known when building, it can be advantageous to choose to make the plates 614 stationary. An alternative boundary 619 for the evacuated space 616 can also be used with the plates 614 at least partially external to the space 616.

The plate 614 to plates 512 distance 620, in FIG. 6, is not static however, since the Fly-Ring 114 is expanding as it speeds up. so that its radially outer edge is approaching the set position of the plates 614. Since the charge separation distance is then also becoming smaller, the factor R⁻² is becoming much greater and hence the effective field felt by the plates 512 is maximizing as the Fly-Ring 114 speed increases to near its maximum. By applying an induced EM potential to the plate 614 it can be made to have a charge distribution 622+ (positive charges)/622− (negative charges) which induces an effective electrostatic field on the Fly-Ring 114 that will exert a radially repulsive (when the plates 614 are properly configured) force that at least partially counters the centripetal force due to faster revolutions which expand the Fly-Ring 114. Since the tensile Fly-Ring 114 strength limit is reached due to circumferential aggregation of centripetal forces, and when the angular frequency of revolution varies it is essentially only the centripetal force component that varies with it, even modest counterbalancing of centripetal forces can provide major increases in the maximum useful angular frequency (which is the payoff in the end since the energy stored is proportional to the square of the angular frequency: ω²). A second positioning based form of varying the effective electrostatic fields involves moving the source of the field itself such as plate 612, which is also producing an electrostatic field due to its induced charges 624+ and 624−. The charges 624 are arranged with the positive side facing the plates 512 since an attractive force is wanted to pull them inward in a second form of centripetal force counterbalancing. These charges might often be left steady, so that the plate 612 can be isolated inside the evacuated space 616. The location of the plate 612 can be altered by a mechanism 626 which has sufficient strength to bear a meaningful portion of the centripetal force as it moves the plate 612 in the radial direction 627. Again, due to the R⁻² relationship by which the EM field varies with distance of separation R, the movement of the plate 612 radially outward closer to the plates 512 increases the effective field magnitude affecting the plates 512. Because the plates 512 will be increasing their distance 628 from a stationary plate 612 as their speed increases (when they need the attractive force of the EM field from plate 612 even more), the attractive force from the plate 612 for the plates 512 will be reduced. By making the plate 612 able to move, and in particular able to move radially outward as either a whole or as a symmetrical distribution of sub plates, such that the distance 628 either remains relatively steady as the plates 512 speed up, or can even shorten when the plate(s) 612 move sufficiently far through the available space 629 (a fraction of the raceway width 630) which separates the plate(s) 612 from the plates 512.

Another alternative aspect of the sixth embodiment is distinct electrostatic potentials inducing the charge imbalances in plate(s) 612 and plate 614 which create the electrostatic fields that effect an at least partial counterbalancing of the centripetal forcing of the plates 512. By utilizing separate electrostatic field sources and separate control means, differing (as well as the same when wanted) electrostatic field magnitudes are available for each of the plates 612 and 614. Greater flexibility and/or more varied capabilities in the manner of applying the electrostatic forcing is hence made available since each of the plates 612 and 613 can induce electrostatic fields independently.

A general set of dimensional relationships of a Fly-Ring 114 sixth embodiment installation 710 is shown in relation to the expanded view 610 by the connecting lines 611 showing the relative size of the raceway width 630 in FIGS. 6 and 7. In general, an excavation 712 of diameter 714 will be sized to be relatively close to twice the radius of the Fly-Ring 114. The unprecedented size of the Fly-Ring 114 enables substantial surface area for close interactions by the Fly-Ring 114 with a top surface 716 which does not alter its location as the Fly-Ring 114 speeds up as well as a magnetic levitating apparatus 718 (depicted symbolically). A variety of options are available for filling in the excavation 712 with differing aggregates or composites 720.

A second set of dimensional relationships are depicted in a Fly-Ring 114 seventh embodiment's expanded detail schematic cross-section view 810 showing a circular cross-section torus 812 of interior diameter 814 within which the defined space 618 for the Fly-Ring 114 is disposed. Additionally, a simpler form of electrostatic potential inducement is depicted in which a single electric potential 816 (depicted symbolically by an electric power line 816) provides the electromotive force for inducing the charge concentrations (and hence the electric potential between them induced by the charges) in both of the plates 612 and 614.

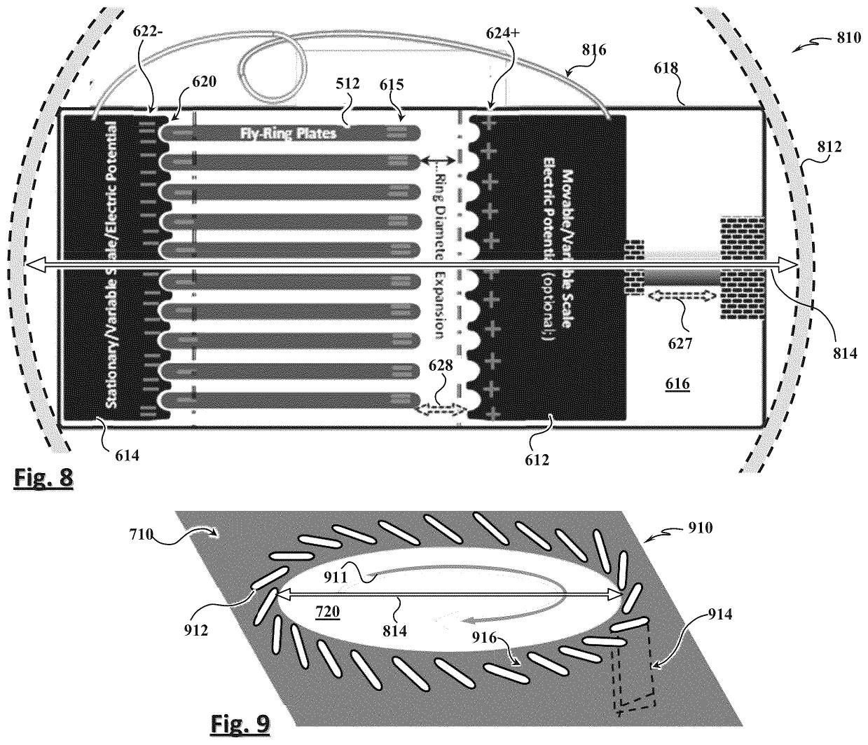

A failure mitigation tactic 910 is depicted in FIG. 9, showing a perspective view of a Fly-Ring excavated cavity 720 in which the Fly-Ring 114 revolves, for example, in a clockwise direction 911. Since it is not impossible for any device to fail, and because many embodiments of the present invention are intended to apply substantial stress to a ring of metal alloy(s) that cannot be manufactured with perfect tolerances, the fact is that failures are gonna happen. Hence, it is prudent to incorporate a lower cost failure damage mitigation approach shown in FIG. 9. A plurality of staves 912 (made from fiberglass, for example) are driven vertically into sunken dispositions 914 wherein they are both spaced and overlapped 916. The overlapping staves 910, when a portion of a failing plate 512 is radially spun outward, will first contact a first portion of a stave 912 which will be turned and moved outward until it catches a second overlapping stave 910. The staves 910 and intermediate dirt and/or fill is then all moved as a large plow of staves, dirt, fill and ejected Fly-Ring 114 material that will slow quickly as it further plows the area around the excavation 720.

A repulsive magnets first arrangement 1010 depicted in FIG. 10 includes permanent magnets 1012 configured into cooperative upper 1014 and lower 1016 magnet arrays, wherein the upper array 1014 is attached to and supports the Fly-Ring 114 when forced upward and the lower array 1016 is attached to and is supported by a foundation 1018 when forced downward. When the foundation 1018 can support sufficient force, the repulsive force between the upper 1014 and lower 1016 arrays is sufficiently strong and the upper array 1014 can impart sufficient force to the Fly-Ring 114 to overcome its gravitational weight then this magnet arrangement and its similarly performing variations can levitate the Fly-Ring 114. Achieving levitation entails surpassing these force thresholds while the Fly-Ring 114 is in operation, i.e. when the Fly-Ring 114 is rotating, is accelerating or decelerating and hence is either growing or shrinking, respectively, in radius due to the speed of rotation changes inducing a modest form of deformation due to centripetal acceleration and hoop stress. These Fly-Ring 114 movements produce constraints on the arrays 1014 and 1016, since particular array variants can vary in the magnitude of repulsive force they produce according to the disposition of the upper array 1014 relative to the lower array 1016. In some array variants, the upper 1014 and lower 1016 arrays produce sufficient force when in a first relative disposition, but can lose the capacity to produce sufficient force in one or more other relative dispositions that are realizable by a Fly-Ring 114 rotating through its expected range of rotation speeds. Hence one advantage of certain magnet configurations is their capacity to maintain sufficient repulsive force when the Fly-Ring 114 changes rotation speeds and hence grows or shrinks, radially. Among the more useful ways to manage the changes in the cooperative relationship between the upper 1014 and lower 1016 arrays as the Fly-Ring 114 and the upper array 1014 change speed and size is by utilizing the geometric attributes of their specific individual configurations. Producing a cooperative spatial relationship between the upper 1014 and lower 1016 arrays that maintains a yield of sufficient repulsive force as the Fly-Ring 114 rotates and expands/contracts can involve relative spatial dispositions that stay steady enough to keep the repulsive force above the levitation threshold.

One issue requiring management when arranging permanent magnets to produce a broad and strong repulsive force is the behavior of magnet blocks when crowded together. Their induced fields are not independent so that, for example, when 16 cube shaped N42 magnets are arranged into a packed, all north poles pointing upward, sides touching, 4×4 square, the total repulsive force produced by that square is much less than the force produced by one of the N42 magnet cubes multiplied by 16. When so closely packed, the 16 magnet cubes act magnetically more akin to a single, 4×4 magnet which expresses the majority of its magnetic field at the borders of the square, but not nearly as much upward repulsive force across its width. Shape, spacing, proportions and how these factors affect the manner of interrelation between the upper 1014 and lower 1016 arrays all can strongly affect the resultant aggregate magnetic field. Geometric factors that affect the aggregate strength of an array of permanent magnets includes their individual dimensions and proportions, as well as their relative spacing and dispositions, and how those relate to the individual block characteristics. It is not a trivial task to produce an effective field across the entirety of the Fly-Ring 114 of sufficient strength to levitate large loads and that remains sufficiently steady as the Fly-Ring 114 changes rotational speeds, and hence changes radial sizes. Hence among the inventive qualities of the embodiments of the present Fly-Ring 114 invention are solutions to this task that provide for effective aggregate fields that are sufficiently strong, uniform, stable and unvarying as the Fly-Ring 114 accelerates and decelerates.

Various embodiments of the present invention include a number of permanent magnet arrangement solutions to the above issues, with many of the solutions characterizable as either (1) single sided with a below Fly-Ring pair of repulsive magnet arrays providing Fly-Ring 114 lifting repulsive force support; or (2) dual sided with both a) the below Fly-Ring pair of facing same-poled magnet arrays providing repulsive force support; and b) an above Fly-Ring pair of facing opposite-poled magnet arrays providing a Fly-Ring 114 lifting attractive force. The first arrangement 1010 is of the single sided type, and as described it encompasses a range of options for disposing the magnets, as well as how the magnets are individually configured, to form the upper 1014 and lower 1016 arrays. Broad families of these types of magnet arrangements fall within the scope of the present invention, and among the manners of specification available to describe these families are differing common attributes. These attributes can include both individual magnetic block characteristics as well as characteristics of part or all of the disposing of the blocks in arrays, and in certain cases more than one characteristic of either the blocks or the arrays can be simultaneously valid (except where obviously contradictory such as if one characteristic is symmetric and the other is antisymmetric). Large ranges of permanent magnet types and arrangements are utilizable, such as Halbach arrays of varying configurations, cup magnets, and no-rectilinear magnet block shapes.

Additional stabilizing magnet dispositions may also be needed in addition to those used for levitating purposes. Even once stable rotation in place is achieved, destabilizing factors such as seismic events and unsymmetrical power transfer aspects can induce ring motion modes that are unstable or even damaging. One advantageous disposition 1020 for the stabilizing magnets is to be distributed about the inner or outer border of the ring, generally at a distance from the bottom or top edge but usually not a great enough distance to become centered between the top and the bottom, and may require supporting structures 1021. Since any variation in force between magnets 1022 would indicate relative and hence destabilizing and hence unwanted motion by the Fly-Ring 114, it is beneficial for the force response of the stabilizing magnets 1022 to be dampened to dissipate energy from any unstable modes of Fly-Ring motion. One of many forms of dampening that are usable with some embodiments of the present invention is a combined restricted flow air piston 1024 and spring 1026 that both provides resilient support to one of the magnets 1022 and dampens down rebound motion by the spring 1026 with the airflow restricted movement of the piston 1024. In some cases, it can be important to space the magnets 1022 with the supporting structure 1021 sufficiently above the upper 1014 and lower 1016 arrays to avoid interfering with their levitation of the Fly-Ring 114. Another benefit that garnered from differing magnet dispositions is to “erect” an EM potential energy well wherein the lowest energy position of the Fly-Ring 114 IS the preferred operating position. Cooperating corner and/or side extensions 1032 and 1034 of the lower 1016 and upper 1014 arrays, respectively, are variously configurable to provide this EM energy well.

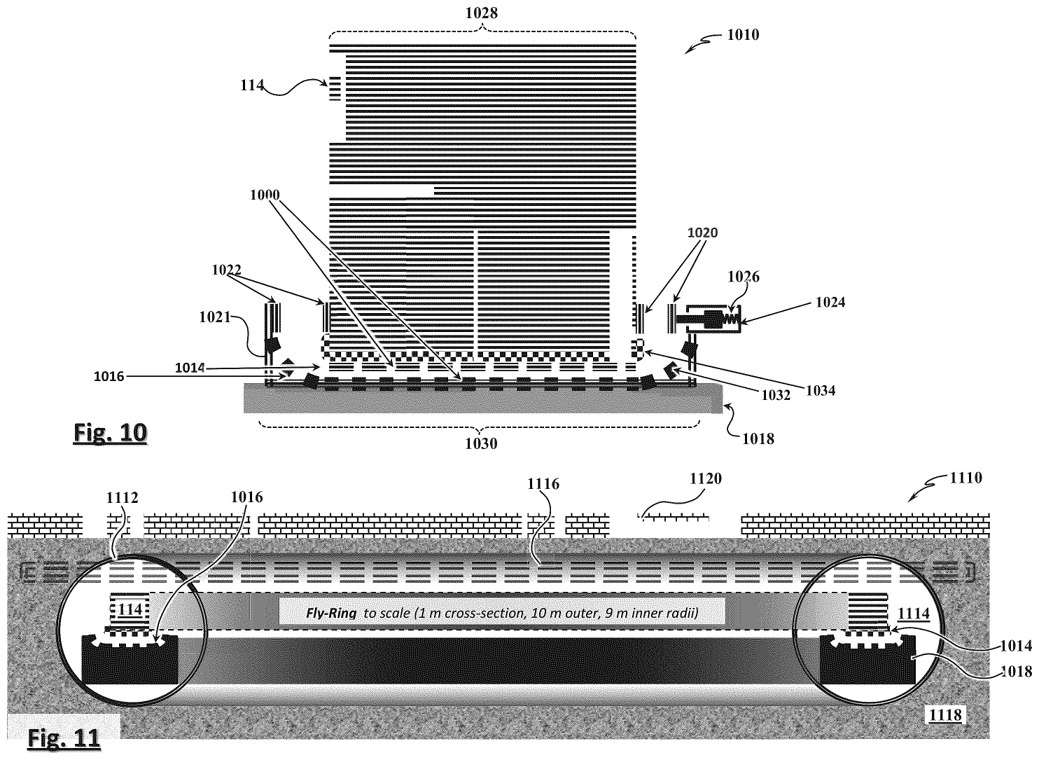

The cross-sectional upper array width 1028 and lower array width 1030 are generally wanted to be maximized for greater economic benefits, since more width generally equates to more magnetic lift which enables more spinning metal which equals much more energy storage (i.e. economic payoff) for not much more cost. As can be seen in the schematic cross-section view of a Fly-Ring installation 1110 shown in FIG. 11, while the Fly-Ring 114 does encompass a significant footprint, the majority of that area is open. The toroidal chamber 1112 has, when in operation, an evacuated interior 1114 that encloses the Fly-Ring 114, associated foundation 1018, magnet arrays 1014 and 1016, and power transfer assemblies (not shown). In a dual sided levitating approach that also includes attractive magnet arrays a second foundational support 1116 can be added to provide support to attractive magnet arrays providing left from above. Generally, the Fly-Ring and associated equipment will be an underground installation 1118, and often a reinforced cap 1120 will cover an installation 1118.

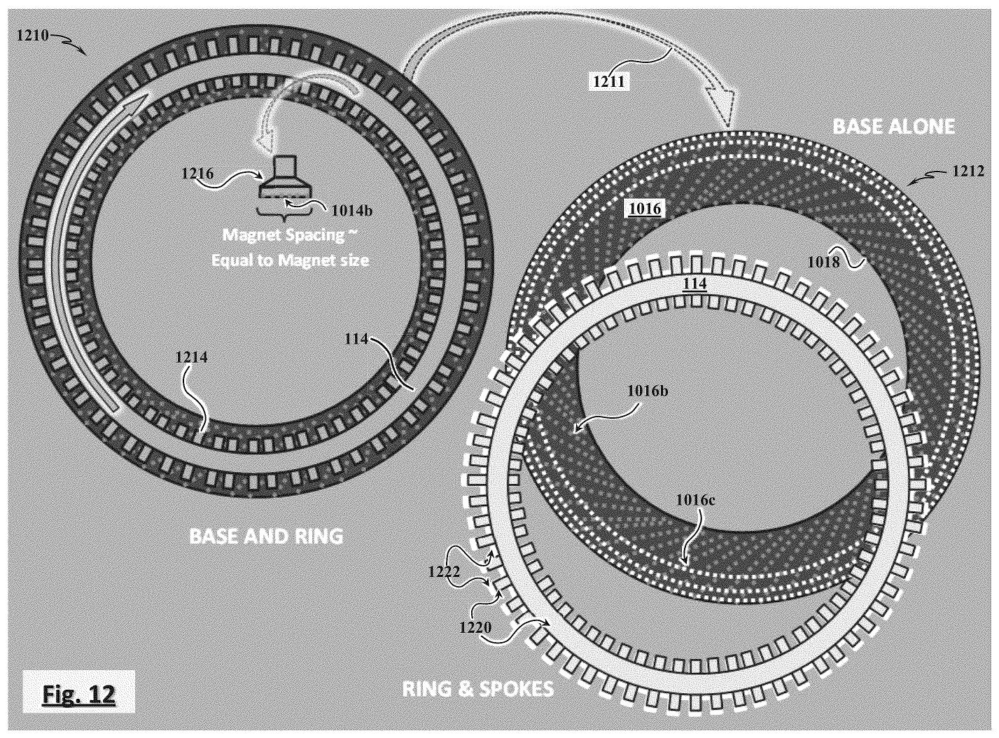

Enabling a Fly-Ring 114 to be lifted by more magnets can increase its economic payoff, since a Fly-Ring 114 of similar planar dimensions is only limited in height (and hence only limited in weight) by the size of the chamber 1112 and the amount of magnetic lift available. One method of increasing the available magnetic lift as seen in the schematic overhead view of FIG. 12, involves increasing the space for disposing magnets such as a first spoked Fly-Ring and base shown in their operational disposition 1210 and alternatively 1211 in separated dispositions 1212. A plurality of radially extending spokes 1214 extend the available room for an enlarged Fly-Ring 114 supporting upper array 1014b. A spoke side view 1216 illustrates one form of usable interrelation between the Fly-Ring 114 and the spokes 1214. Because the spokes 1216 are unconnected they do not experience hoop stress loads. The centripetal stresses that they fig feel are well within the operating parameters of many grades of steel, including those substantially less expensive than the higher performing grades used for the Fly-Ring 114 itself. Of course, the additional weight of the spokes 1216 and additional magnets in the array 1014b will add to the hoop stress felt by the Fly-Ring 114, and the greater value of the spokes is realized when the amount of additional Fly-Ring 114 mass able to be levitated that the spokes 1216 enable more than compensates (in total energy storage capacity) for the reduction in top end rotational speed due to the spokes' 1216 masses' added hoop stressing of the Fly-Ring 114.

By considering the base—foundation 1018—and the Fly-Ring 114 with added spokes 1216 separately 1212, aspects of the distribution of the base disposed magnets and the behavior of the Fly-Ring 114 at speed can be shown more clearly. The magnet array 1014b involves a large plurality of radially directed spokes 1216 upon which the magnet blocks are linearly aligned. It should be understood though that in operation the Fly-Ring 114 will essentially never by stationary. Hence, the normal state in which it needs to be levitated is rotating at some speed within its limits (generally up to within a reliability/safety dictated percentage of the Fly-Ring's 114 hoop stress limit). The magnets of array 1014b are then rotating relative to the magnets of array 1016b that are anchored to the base foundation 1018. As the Fly-Ring 114 rotates faster and faster, the increasing hoop stress will result in an overall expansion of the Fly-Ring 114 itself, generally in the range of 1 to 2% at its greatest. Comparison of the very slowly moving Fly-Ring and spokes sizes 1220 to the same Fly-Ring and spokes at high speeds 1222, now outlined in white, reveals both the scale and the symmetry of the expansion of the Fly-Ring 114 and spokes 1214. While the scale of the expansion appears quite small, it must be remembered that the Fly-Ring 114 shown could have a 20 meter, or diameter. The movement radially outward then of a portion of the array 1014 relative to array 1016 could be in the range of inches, which is comparable in some arrangements to either or both the size of the magnetic blocks as well as their separation distances. What is needed then are magnet arrangements which maintain their lift force when array 1014 is rotated throughout 360 degrees relative to array 1016, and which maintains this force even as the radial distance alignment between 1014 and 1016 also changes by a block size or more while fully rotating. A few approaches can yield positive results, in particular when combined. A first approach is for the aggregate degree of overlap of blocks and spaces of the arrays 1014 and 1016 to be relatively steady during rotation, though any individual block and space will have widely varying degrees of overlap. The slanted arrangements 1016b in combination with the straightly radial array 1014b arrangements produce an overlapping composite pattern that is essentially steady as the Fly-Ring 114 rotates, the circular added base magnet block arrangements 1016c are an optional stability enhancing feature wherein the extra magnets produce a lower energy state for the Fly-Ring 114 when it is stably centered about its rotational axis, since it is lifted against gravity by the magnets 1016 as it moves outward. The greater density per radial distance of the magnet blocks of arrangement 1016b as the radial distance decreases also provide a lower energy state with the Fly-Ring 114 centered.

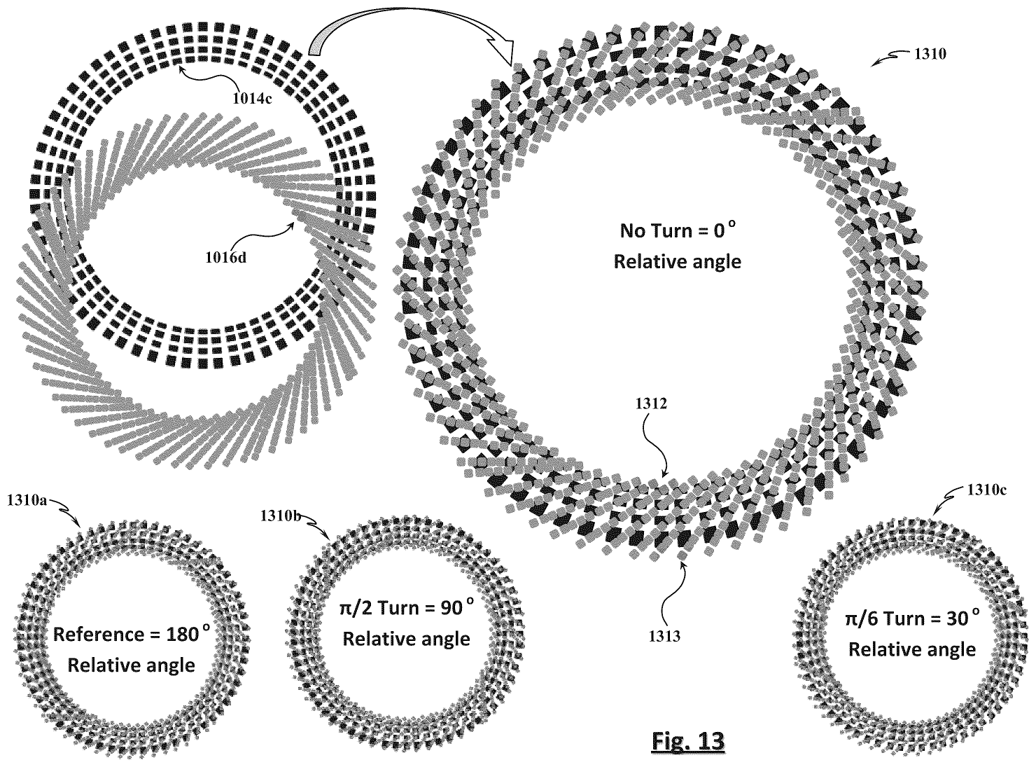

Shown in FIG. 13 is a second combined upper and lower array 1310 that achieves rotational and expansion symmetries. Arrays 1310 are similar to 1014b and 1016b, except that the spacing between magnet blocks is less than the size of the blocks themselves. As can be seen at the inner 1312 and outer 1313 borders the base disposed magnets of arrays 1310 extend both inward and outward more than the ring disposed magnets to account for the ring's expansion. Four relative dispositions of the upper and lower arrays 1310 are shown from a nominal starting point of 0 relative degrees rotation 1310, to a full half rotation of 180° in 1310a, a quarter rotation of 90° in 1310b, and a small rotation of 30° in 1310c. Inspection of the overlaps and open gaps in 1310, 1310a, 1310b and 1310c reveal little if any distinguishability, and hence rotational symmetry. Similar inspections with differing expanded upper sizes of 1014c relative to 1016d are also virtually inseparable.

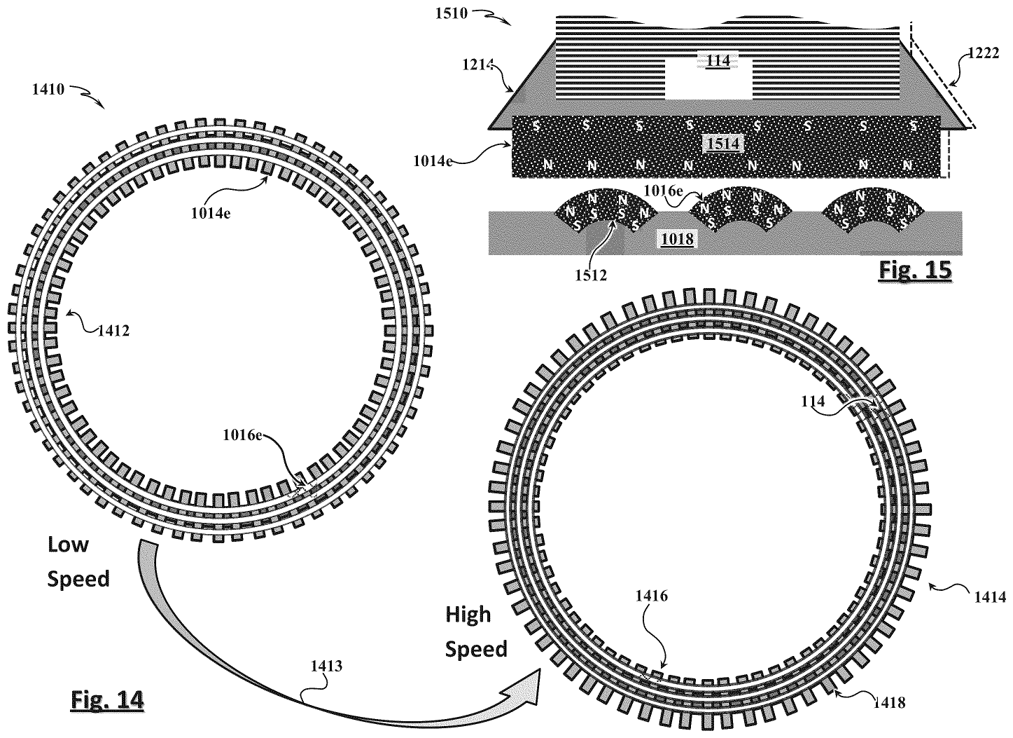

FIG. 14 shows a below view of another overlap arrangement 1410 with another manner of cooperatively arranging an upper array 1014e and a lower array 1016e. The array 1016e consists of circular magnet block configurations, centered on the planar center of the Fly-Ring 114 and affixed to the foundation 1018. As seen in schematic cross-section in FIG. 15, the blocks forming array 1016e may be arranged so that they present an arc 1512 or similar geometry wherein the ends of its blocks, where the flux lines pass to the other pole, are further separated from the magnets of array 1014e that are rotating overhead. These flux lines can interfere with the aggregate levitating force produced, and as with all EM phenomena, the strength of the interaction varies with distance by a factor of r⁻², so that the extra separation can attenuate any unwanted repulsion lessening or attraction engendering EM interactions in favor of the less distant repulsion increasing interactions desired. Another manner of preserving the wanted level of repulsion as the Fly-Ring 114 slows and/or speeds up are a number of radially extended blocks 1514 that are sufficiently large in the radial direction so that their expansion or reduction in size to not significantly change the spatial relationships between array 1014e and array 1016e. As seen when comparing the slow rotational speed relative dispositions 1412 of the arrays 1014e and 1016e to high rotational speed (after acceleration induced transition 1413) dispositions 1414, the spokes' 1214 internal ends still extend inside of the arrays 1016e, while their external ends 1418 extend well beyond the outermost of the arrays 1016e. These distances are sufficient so that the magnetic relationship of the arrays 1014e to the arrays 1016e remains relatively steady as the transitions between dispositions 1412 and 1414 occur. The extent of the spokes 1214 that is further from the array 1016e in the slower rotating dispositions is the opposite of the faster rotating ones, such that the innermost extents of the spokes 1214 are more exposed than their more outward extents when in the disposition 1412.

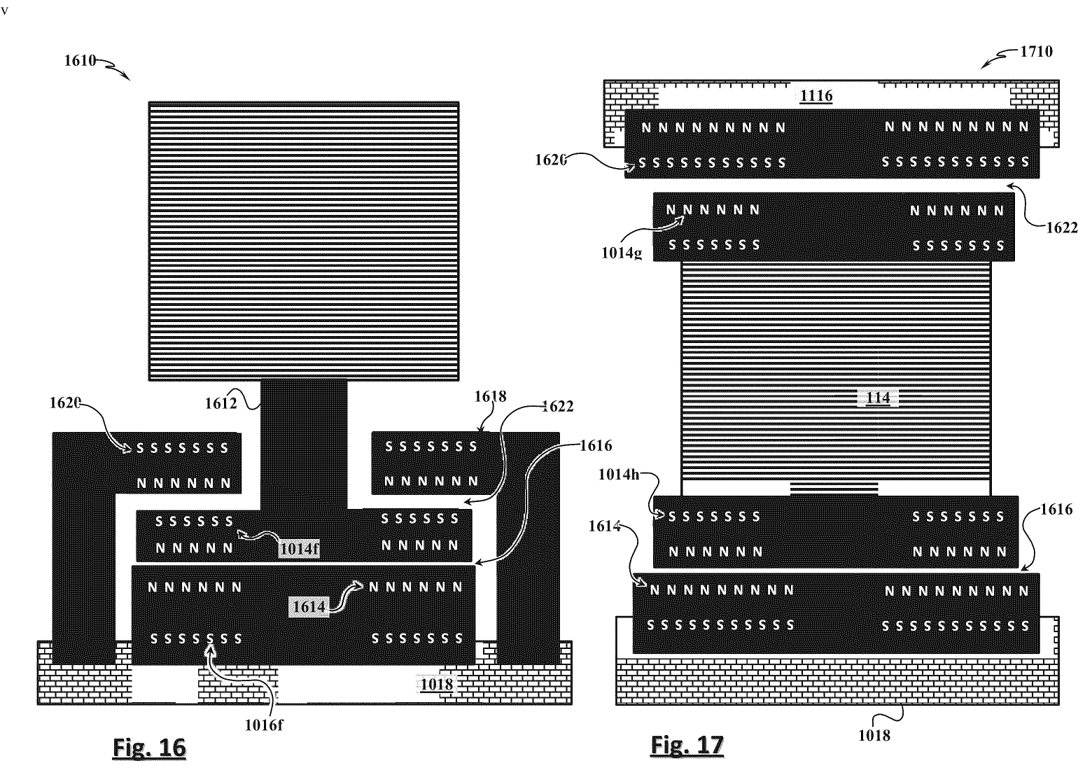

FIG. 16 depicts a first dual sided levitating arrangement 1610 where the Fly-Ring 114 is supported upon a pedestal 1612 with an upside down T cross-section. As shown in FIG. 16, the cross-section view is of the left side of a Fly-Ring 114, and hence its expansion when speeding up will be from right to left. An array 1014f of magnets with aligned vertically stacked poles. S above and N below as shown, are aligned along the wings of the pedestal 1612. Below the wings is a repulsive (like pole closest to like pole 1614) foundation 1018 supported magnet array 1016f. The normal resting, dual-sided levitated vertical position of the Fly-Ring 114 provides for the separation 1616 between the top of the bottom array 1016f and the bottom of the pedestal 1612 to have a magnitude of X. Above the wings of the pedestal 1612 are a pair of inner and outer rails 1618 supporting a magnet array 1620 with poles arranged for attraction by alignment closest to the opposite poles of array 1014f. The normal resting, dual-sided levitated vertical position of the Fly-Ring 114 provides for the separation 1622 between the top of the array 1014f and the bottom of the array 1620 to have a magnitude of 2× or more. Any vertical movement of the pedestal 1612 will increase or decrease separations 1616 and 1622 by the same amount, though in opposite directions (when one increases, the other decreases). As long as the magnitudes of the two forces of repulsion across separation 1616 and attraction across separation 1622 are roughly within the same order of magnitude, an initial small vertical movement of ΔX will be a substantially larger percentage change of the distance 1616 than of the distance 1622. Once amplified by the factor r⁻², this difference is magnified and hence the repulsive lift force will either grow or decrease faster than the attractive lifting force will decrease or grow, respectively, with small vertical Fly-Ring 114 movements ΔX. The repulsive lifting force is inherently stable while the attractive lifting force is inherently unstable. Using both enables levitating greater masses with greater economic returns. By having the difference in the separations 1616 and 1622 as described, the inherently stable behavior of the repulsive force will dominate over the unstable behavior of the attractive force, and both can then be used safely.

In the second dual sided levitating configuration 1710 shown in FIG. 17, an overhead support 1166 supports attractive array 1620 a separation 1622 above a Fly-Ring supporting upper array 1014g. A Fly-Ring lower array 1014h supports the Fly-Ring 114 and is repulsed to a separation 1616 from the foundation 1018 supported array 1614. The separations 1616 and 1622 are again related akin to their relationship in FIG. 16 so that the configuration 1710 can again take stable advantage of both attractive and repulsive permanent magnet levitation.

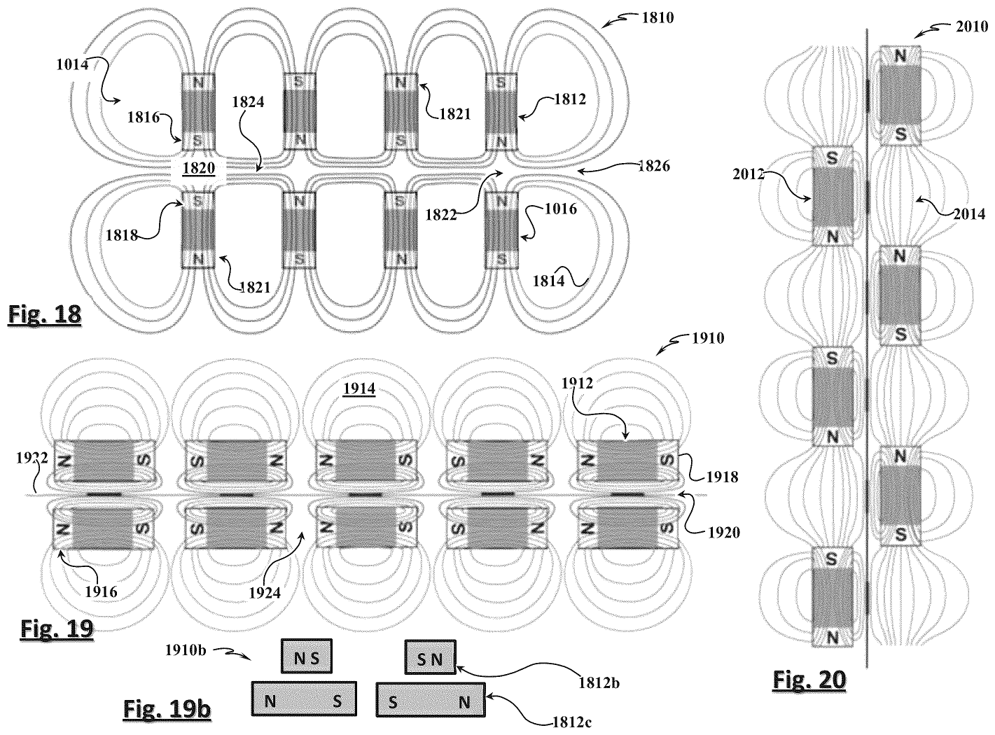

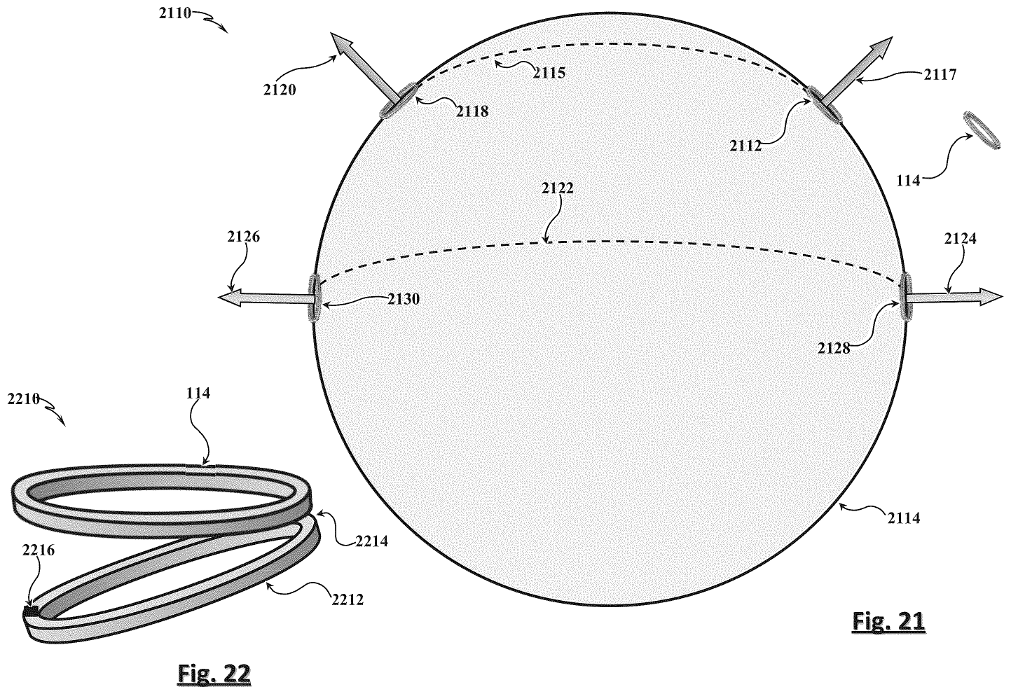

As shown in FIGS. 18-20, the effective magnetic forces acting between (and all around) the arrays 1014 and 1016 are affected by a number of factors. These factors are generally combinable so that more than one kind of variation is employable at the same time. Factors available to vary already described include magnet block dimensions, inter-block spacings relative to block sizes, block alignment patterns and inter-array block and block arrangement aspects among others. One area of engineering where a large amount of work is done to control EM driven elements is audio reproduction speaker design. Among the approaches used are those employing magnetic forces to drive a transducer to create sound waves. One such set of designs are described as magnetic planar drivers and they produce an isodynamic (directionally balanced forces) state in a diaphragm between them that is then moved by the magnets to create sound. What is also possible to do with this setup is to remove the diaphragm which does not change the isodynamic forces present, which also serve to force the arrays producing them apart. These arrays are then adapted to maximize this force to produce the levitation needed by the present invention. These arrays are also adaptable to other forms of magnetic forcing needed such as instability dampening. Certain of these arrays also have a previously detailed desired feature wherein as their moving array to stationary array spatial relationship changes with changing Fly-Ring 114 rotation speeds, their inter-array magnetic forces are generally steady, often due to the block by block inter-array spatial relationships being sufficiently steady as the rotational speeds change. A rust inter-array block arrangement 1810 shown in FIG. 18 depicts both the magnet blocks 1812, their dispositions and a representative number of magnetic field lines 1814. The upper array 1014 and lower array 1016 are initially aligned with each upper block's S pole 1816 disposed close to the lower arrays' block's S pole 1818 and the spaces between them lined up facing each other divided by a space 1820, and those blocks' N poles 1821 aligned away from each other. As seen in FIG. 18, the field lines from both arrays “push” and affect each other both at the block to block junctures 1822 and the spaces between blocks 1824. The blocks of each array are also similarly alternated in the radial direction with blocks having their S pole facing down having on each side blocks with N poles facing down, and vice versa. The repulsive fields are thereby concentrated in the inter-array zone 1826 which then produces more repulsive lift.

A second inter-array block arrangement 1910 shown in FIG. 19 depicts both its magnet blocks 1912, their dispositions and a representative number of magnetic field lines 1914. In the second arrangement 1910, both the upper and lower arrays blocks' 1912 are laid on their side with the axis between their N 1916 and S 1918 poles aligned parallel to the separation space 1920 between the arrays. (An optional diaphragm 1922—which is used by the designers of similar systems to drive air for sound reproduction—can be used in the present invention also for both safety indication and/or sensor support.) The blocks 1812 are arranged in alternating alignments along each array, so that a first block's S pole 1918 is faced across the separation 1924 by the next block's S pole 1918. That second block's N pole 1916 is then faced across the next separation 1924 by a third block's N pole 1916, and the third block's S pole 1918 is faced across the next separation 1924 by a fourth block's S pole 1918, and so on. The repulsive fields are thereby concentrated in the inter-array zone 1920 which then produces more repulsive lift. An alternative variant 1910b for the upper and lower array block sizes is shown in FIG. 19b. The blocks 1812b are attached to the rotating Fly-Ring 114 and hence change radial positioning with changes in Fly-Ring 114 speed. Their dimensions are sized small enough relative to the radial extent of the stationary array blocks 1812c so that as they move radially their magnetic force environment is relatively stable, and hence the repulsive force produced remains relatively stable.

A third inter-array block arrangement 2010 shown in FIG. 20 depicts magnet blocks 2012, their dispositions and a representative number of magnetic field lines 2014. The arrangement 2010 is similar to the arrangement 1910, though altered with an alternating omission of one block from each array, and then a modest tightening of the radial spacings between the blocks 2012.

When rotating in place at a particular spot 2112 on the earth's surface 2114 at a latitude 2115 that is not on the equator 2116 the Fly-Ring 114 will have a significant angular momentum 2117 that is normal to the earth's surface 2114 at that point in time and space. The earth anchored parts of an operating Fly-Ring installation 1110 will change position with the earth's rotation and assume the position 2118 at a later time in the day. For the Fly-Ring 114 to be positioned correctly relative to the rest of the installation 1110 at that later time, its angular momentum must be changed from 2114 to 2120, and in fact that has to occur as a continuous process in keeping with the movements of the installation 1110 as it rotates with the earth as the day evolves. A Fly-Ring installation 1110 on the equator 2122 will undergo a need for 180 degree switches in the direction of the angular momentum from 2124 to 2126 when the installation 1110 shuttles between positions 2128 and 2130. Due to the levitating nature of the Fly-Ring 114, it will not naturally change orientation as the installation 1110 does through the day. Hence a specific 24 hour progression of orientation changes are needed to be applied to the Fly-Ring 114 in order to maintain its correct positioning relative to the installation 1110. EM forcing with electro magnets is one available approach to precession mitigation, though it may not be the most energy efficient approach. Another approach utilizes a precession neutralizing ring 2212 in close proximity 2214 and tilted relative to the Fly-Ring 114, with a particularly strong magnet 2216 affixed to the ring 2122 which has a point of closest proximity at 2214. The neutralizing ring 2212 is turned towards 2214 in concert with the precession of the Fly-Ring 114, so that the magnet 2216 spends 12 hours shifting and getting closer to the Fly-Ring 114 and then 12 hours shifting and getting farther from the Fly-Ring 114. Appropriate distance and magnet magnitude choices will effectively counter the Fly-Ring's 114 precession as it rotates about the earth.

What is claimed:

1. (canceled)

2. (canceled)

3. (canceled)

4. (canceled)

5. (canceled)

6. (canceled)

7. A Fly-Ring kinetic energy storage system, comprising:
a rotationally symmetrical, open center, primarily metal alloy ring;
a raceway arranged to accommodate the ring as it rotates in place;
a raceway associated, magnetic levitation system with more lifting force than the ring's weight;
power electronics that store power in the form of increased ring rotational speed by using the supplied power to accelerate the ring and retrieving power for return by decelerating the ring;
wherein the ring has an outer radius of at least 5 meters and at least 200 metric tons mass.

8. A Fly-Ring kinetic energy storage system according to claim 7, wherein the metal alloy is one or more of a maraging steel, a martensitic steel alloy, a similarly high tensile strength engineered steel alloy; and/or has a tensile yield strength of either at least 1000 Mega Pascals or at least 2000 Mega Pascals.

9. (canceled)

10. (canceled)

11. A Fly-Ring kinetic energy storage system according to claim 7, wherein the ring has an inner radius of at least 8 meters and an outer radius of no more than 11 meters.

12. A Fly-Ring kinetic energy storage system according to claim 7, wherein the ring has an inner radius of at least 13 meters and an outer radius of no more than 16 meters.

13. A Fly-Ring kinetic energy storage system according to claim 7, wherein the ring has an inner radius of at least 18 meters and an outer radius of no more than 22 meters.

14. A Fly-Ring kinetic energy storage system according to claim 7, wherein the ring has at least 400 metric tons mass.

15. A Fly-Ring kinetic energy storage system according to claim 7, wherein the ring has at least 900 metric tons mass.

16. A Fly-Ring kinetic energy storage system according to claim 7, wherein the ring is composed of a plurality of vertically stacked metal alloy plates that can be optionally spaced vertically apart.

17. (canceled)

18. A method of storing energy in the rotations of a Fly-Ring KESS, comprising the steps of:
constituting, primarily from one or more ultra-high tensile yield strength metal alloys, a large entirely open core ring of inner radius Rᵢ, outer radius Rₒ, and radial thickness ΔR=Rₒ−Rᵢ;
levitating the ring magnetically with permanent magnets, distributed along the extent of the ring and an associated raceway, that collectively lift with more force than the ring's weight;
rotating the ring in place such that each section follows the adjacent section stably at varying angular velocities without a stabilizing central structure;
accelerating and/or decelerating the ring's rotation with power electronics that transfer energy to the ring by speeding the rotation and receive energy from the ring by slowing its rotation; wherein Rᵢ is 2 meters or greater and ΔR is less than Rᵢ and less than 3 meters.

19. A method of storing energy in the rotations of a Fly-Ring KESS according to claim 18, wherein Rᵢ is 4 meters or greater, ΔR is less than 1.5 meter, and the space in which the ring rotates is at least partially evacuated.

20. A kinetic energy storage system, comprising:
a steel ring having an inner radius of at least 4 meter and an outer radius 2 meters or less larger than the inner radius,
an electromagnetic (EM) power transfer assembly that causes the ring to selectively rotate faster and/or slower in order to store energy as or retrieve energy from the ring's rotation, and
one or more arrays of permanent magnets arranged to provide sufficient lift to the ring so that the ring is levitated off of the ground.

21. A kinetic energy storage system according to claim 20, said magnet arrays comprising a first array affixed to the ring and a second array supported, directly or indirectly, by the ground, a foundation or the equivalent thereof;
wherein the arrays are disposed in cooperative positions such that the EM interaction between them partially provides, via the first array lifting the ring due to the EM interaction, sufficient force to levitate the ring.

22. A kinetic energy storage system according to claim 21, wherein said first and second arrays each consist of magnets disposed with their poles all similarly aligned, normal to the width of the ring, and such that the same magnetic pole face of the first array are all disposed closest to the same magnetic pole face of the second array.

23. A kinetic energy storage system according to claim 21, wherein said first and second arrays each consist of magnets disposed with similar alignments that create similar fields normal to the width of the ring and are placed in mirror image facing dispositions producing a repulsive magnetic force between them.

24. A kinetic energy storage system according to claim 21, wherein said first and second arrays consist of magnets disposed with opposite poles facing each other and are placed in dispositions producing an attractive magnetic force between them.

25. A kinetic energy storage system according to claim 21 further comprising third and fourth arrays, wherein said first and second arrays consist of magnets disposed with opposite poles facing each other and are placed in dispositions producing an attractive magnetic force between them, and said third and fourth arrays produce a repulsive force between them with the first and second arrays' attraction pulling the ring upward from above and the third and fourth arrays pushing the ring upward from below.

26. A kinetic energy storage system according to claim 25, wherein said attractive and repulsive EM forces are arranged such that as a vertical displacement of the ring occurs, the repulsive force pushing upward from below drops in aggregate magnitude faster than the attractive force pulling upward from above grows in aggregate magnitude.

27. A kinetic energy storage system according to claim 25, wherein said attractive and repulsive EM forces vary according to r⁻², with r₁₂ being the distance between the first and second attractive arrays and r₃₄ being the distance between the third and fourth repulsive arrays, and when the ring is in its selected range of stable elevation, r₁₂ is substantially greater than r₃₄.

28. (canceled)

29. (canceled)

30. The Fly-Ring kinetic energy storage system according to claim 7, wherein the metal alloy is non-magnetizable, has a density greater than 4000 Kg/m³ and a tensile yield strength greater than 1000 Megapascal, the ring has an inner radius Rᵢ and an outer Radius R₀ with Rᵢ being at least 2 meters, Rₒ is at least 4 meters, and Rₒ minus Rᵢ is less than 3 meters.

31. The Fly-Ring kinetic energy storage system according to claim 7, wherein the raceway accommodates the rotating ring in an at least partially evacuated space.
